(19) United States
(12) Patent Application Publication
(10) Pub. No.: US 2022/0081056 A1
(43) Pub. Date: Mar. 17, 2022

(54) System For Improving The Performances Of A Cyclist On A Bicycle

(71) Applicant: BLUBRAKE S.R.L., Milan (IT)

(72) Inventors: Fabio Todeschini, Milan (IT); Andrea Verzaglia, Cislago (VA) (IT); Luca Speziali, Caiolo (SO) (IT); Daria Vasile, Rogeno (LC) (IT)

(21) Appl. No.: 17/423,918

(22) PCT Filed: Mar. 3, 2020
(86) PCT No.: PCT/IB2020/051803

§ 371 Date: Jul. 19, 2021

(30) Foreign Application Priority Data
Mar. 20, 2019 (IT) 102019000004069

(51) Int. Cl. B62J 45/20; B62J 45/415; B62J 50/22; B62J 45/412; A63B 69/16; A63B 24/00

(52) U.S. Cl. CPC B62J 45/20; B62J 45/415; B62J 50/22; A63B 2024/0068; A63B 69/16; A63B 24/0059; B62J 45/412

(57) ABSTRACT

A system (1) for improving the performances of a cyclist on a bicycle (100) includes:
one or more sensors adapted to sense kinematic parameters of the bicycle (100) and to provide signals representative of the same;
a control unit (5) configured to:
receive, at the input, the signals from said one or more sensors adapted to sense bicycle (100) kinematic parameters;
determine, from the signals representative of the bicycle kinematic parameters:
the presence or absence of a bicycle (100) downhill condition;
if the downhill condition presence is determined, the presence or absence of a braking action;
one or more parameters representative of the cyclist downhill performances;
make available to the cyclist the one or more parameters representative of the cyclist downhill performances.

### TECHNICAL FIELD OF THE INVENTION

The present invention refers to a system for improving the performances of a cyclist on a bicycle, particularly to a system adapted to assist a cyclist to improve his/her performance limits obtained during preceding training activities. Particularly, the system relates to an improvement to the downhill performances of the cyclist. In addition, the system can find a use for improving the horizontal performances of the cyclist.

### PRIOR ART

Systems assisting a cyclist to brake devised to adapt to the cyclist behavior are known.

For example, the Applicant has filed the international patent application PCT/IB2018/058767 regarding a system for assisting a cyclist on a bicycle to brake by a haptic feedback, wherein an actuator vibrates at a determined vibration frequency if sliding conditions and/or flip-over risks of the front wheel are sensed. The operation of such system is based on a comparison among effective motion conditions, sensed by bicycle sensors, and on reference conditions updated as a function of a learning system which update them based on a classification of the preceding performed brakings. The actuator vibration is managed based on a comparison between effective conditions and reference conditions which are updated. Due to the adaptive haptic feedback, the cyclist is capable of gradually modifying its braking behavior, possibly for obtaining better performances.

Obviously, this system requires suitable instruments, such as vibration generating actuators and a unit for controlling the former.

### BRIEF SUMMARY OF THE INVENTION

It is an object of the present invention to make available a system which can both assist a cyclist to improve his/her performances, particularly if he/she is going downhill, and structurally simple so that it does not make excessively heavier and more complex the structure of the bicycle.

This and other objects are met by a system for improving the performances of a cyclist on a bicycle according to claim 1.

The dependent claims define possible advantageous embodiments of the invention.

### BRIEF DESCRIPTION OF THE DRAWINGS

The invention will be better understood, and the advantages thereof will be appreciated by the following exemplifying non-limiting embodiments which will be described with reference to the attached drawings, wherein:

FIG. 1 is a schematic illustration of a bicycle provided with a system for improving the performances of a cyclist according to a possible embodiment of the invention;

FIG. 2 is a map illustrating an exemplifying route followed by a cyclist;

FIG. 3 is a diagram regarding the trend of the speed as a function of the time of the bicycle along the route of FIG. 2;

FIG. 4 is a detail of the map in FIG. 2.

### DESCRIPTION OF THE EMBODIMENTS OF THE INVENTION

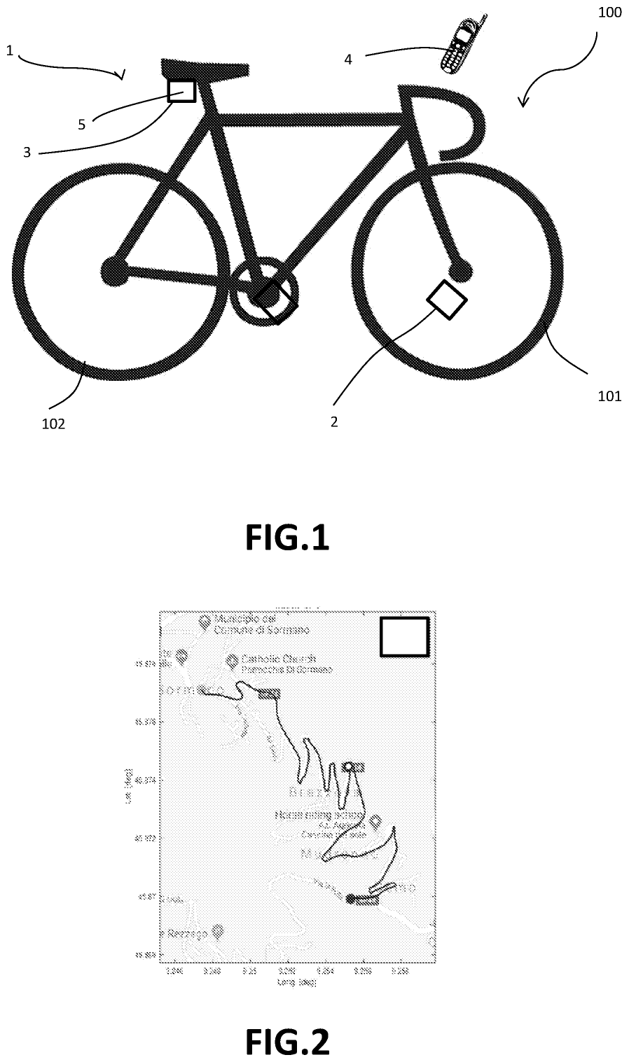

Referring to FIG. 1, reference 100 generally indicates a bicycle. The bicycle 100 comprises a first 101 and a second 102 wheels, for example corresponding to the front and rear wheels. At least the first wheel 101 is associated to a brake actuatable, for example, by a knob placed on the handlebar. The braking system can be of any known type, for example a pad or disk brake commanded by a mechanical system, for example a cable, or can be of a hydraulic type.

Bicycle 100 comprises a system 1 for improving the performances of the cyclist on the bicycle 100, particularly downhill. System 1, as it will be explained, enables the cyclist to execute a real-time analysis and/or an “a posteriori” analysis of his/her downhill behavior in order to improve his/her performances.

For this matter, the system 1 comprises one or more sensors adapted to sense kinematic parameters of the bicycle 100.

According to an embodiment, such sensors comprise a sensor 2 for measuring the angular speed of one of the bicycle 100 wheels, preferably the angular speed ω₁ of the first wheel 101, particularly of the front wheel. The first sensor 2 is adapted to output a signal representative of such angular speed of the first wheel. Such first sensor 2 transmits the signal representative of the angular speed ω₁ of the first wheel 101, preferably wirelessly. Alternatively, the signal can be transmitted by wire. By the signal representative of the angular speed ω₁ of the first wheel 101, the braking condition of the bicycle can be determined, as will be explained in the following. Further, the linear speed of the bicycle v can be calculated from the angular speed ω₁ by the formula v=ω₁·R₁, wherein R₁ is the wheel radius by which the angular speed ω₁ is determined.

Moreover, it is observed that, according to a further embodiment, the bicycle braking can be determined, as an alternative, by a sensor for sensing the braking actions of a user (not shown in the figures) suitable to supply a signal representative of the same. For example, such sensor can comprise a switch (not shown in the figures) coupled to the bicycle 100 brake lever, capable of sensing when this latter is actuated by the cyclist.

According to an embodiment, the sensors adapted to sense the kinematic parameters of the bicycle comprise an inertial measuring unit 3 adapted to measure one or more of the longitudinal aₓ, lateral a_{y} and vertical accelerations a_{z}, and/or one or more of the roll ωₓ, pitch ω_{y} and jaw angular speeds ω_{z} of the bicycle, and to output signals representative of the same.

More information can be obtained by the signals from the inertial measuring unit 3, which for example are:
the slope angle θ (in other words if the bicycle is horizontally moving or is moving uphill or downhill), corresponding, in other words, to the angle comprised between the bicycle speed vector v and the horizontal;
the bicycle linear acceleration or deceleration;
the cyclist lean in a curve, in other words, the bicycle roll angle.

It is observed that different criteria can be applied to determine the slope angle θ by the signals from the inertial measuring unit 3. For example, the slope θ can be obtained from signals representative of bicycle inertial magnitudes, for example according to M. Corno, P. Spagnol, S. M. Savaresi S in “Road Slope Estimation in Bicycles without Torque Measurements”. According to a possible alternative embodiment, the system 1 can comprise a dedicated slope sensor adapted to supply a signal representative of the same.

According to a possible embodiment of the invention, the system 1 comprises a GPS module adapted to geolocate the bicycle 100, in other words capable of determining the bicycle absolute position and of supplying a signal representative of the same. The GPS module can be integrated in the system 1, or as an alternative, can be included in a device outside the system connected on the same. For example, the GPS module can be comprised in a mobile device 4, such a cellphone, or smartphone connected to the system. The GPS module comprises prestored or downloadable maps.

System 1 comprises a control unit 5 connected, preferably wirelessly, or alternatively, by wire, to one or more of the abovementioned sensors, according to embodiment variants of the system 1. Control unit 5 can be positioned in any part of the bicycle, for example the saddle or saddle tube. Control unit 5 can be for example received in a preferably watertight housing.

According to an embodiment, the control unit 5 comprises a counter for counting the time. Specifically, as it will be shown, the counter is for determining the time elapsing between two distinct events.

According to an embodiment, the system 1 comprises a user interface device connected, preferably wirelessly or by wire, to the control unit 5. Such interface device comprises, for example, an input/output device enabling the cyclist to see information provided by the control unit 5 and to input instructions to the same. For example, such user interface device can comprise a monitor provided with a keypad or a touchscreen monitor. According to a possible embodiment, the beforehand cited user interface device is integrated in the outer mobile device 4, cellphone or smartphone, connected to the control unit 5 preferably wirelessly. To this end, the control unit can comprise a wireless transmission module, for example a Bluetooth module for communicating with the outer mobile device, which in turn will be provided with an analogous wireless transmission module.

According to a possible embodiment, the system 1 comprises a data communication module, such as for example a GSM module, in order to remotely transmit data received and/or processed by the control unit. The data communication module can be integrated in the system 1 itself, for example can be associated to the control unit 5, or, alternatively, the system 1 can use the data communication module of the mobile device 4, for example cellphone or smartphone, to which the control unit 5 can be connected according to the beforehand described modes. The GSM module can also be used for receiving data. For example, such GSM module can be used for downloading maps of the GSM module.

The control unit 5 is configured to:
receive, at the input, the signals from said sensors of the system, particularly from one or more sensors associated to the bicycle kinematic parameters, and from one or more other sensors (particularly a GPS module) if provided;
determine, by the signals from said sensors:
   the presence or absence of a bicycle downhill condition. Such condition can be determined for example by signals from the inertial measuring unit;
   if a downhill condition is determined, the presence or absence of braking. Such condition can be determined for example based on the trend of the angular speed ω₁ supplied by the speed sensor 2 or, alternatively, from the sensor for sensing the brake action of the user;
determine one or more parameters representative of the cyclist downhill performances, such as for example:
   the absolute positions of the bicycle when the braking action is started. The absolute position can be determined, for example, by the GSM module;
   the bicycle speed when the braking action starts. The speed can be determined by the signal supplied by the angular speed sensor 2;
   the bicycle 100 absolute position at the end of the braking action. Also, this parameter can be sensed for example by the GPS module. Particularly, the absolute position at the end of the braking action in proximity of a curve is extremely important for the performances;
   the bicycle speed at the end of the braking action. The speed can be determined from the signal supplied from the angular speed sensor 2. Also, in this case, the speed at the start of the curve in proximity of which the cyclist acts on the brake is of interest;
   the braking distance. Such parameter can be determined, for example, by the GPS module or by integrating the distance between the braking start instant and the braking end instant;
   the braking time. Such parameter can be determined by the counter of the control unit 5;
   time taken to travel a curve. Also this parameter can be determined by the counter of the control unit 5, while the start and end points of the considered curve can be determined by the GPS module;
   the bicycle lean angle during the curve. Such parameter can be determined from signals supplied by the inertial measuring unit 5. Travelling a curve by the bicycle can be determined for example by the GPS module or, alternatively, from signals supplied by the inertial measuring system;
   position at the end of the curve. Such parameter, representative of the trajectory followed by the cyclist in the curve, can be determined by the GPS module;
   the speed at the end of the curve. Such parameter can be determined by the signal supplied by the angular speed sensor 2;
   average values of one or more of the parameters sensed between a route start point and end point, such as for example: average curve travelling speed, average lean angle.

The one or more parameters representative of the cyclist downhill performances can be made available to the cyclist according to different modes.

According to a possible embodiment, the control unit 5 is configured to provide real-time parameters representative of the cyclist downhill performances, in other words when the cyclist is effectively travelling the route by bicycle. According to such mode, the control unit 5 transmits the parameters to the user interface device, as hereinbefore defined, which in turn displays them to the cyclist on its monitor.

According to a possible embodiment, the control unit 5 is configured to provide “a posteriori” parameters representative of the cyclist downhill performances. To this end, the control unit can be configured to transmit such parameters to an external device so that the cyclist can display them after the training activity on the bicycle. For example, such parameters can be transmitted, by said modes, to the external mobile device, for example a cellphone or smartphone. As an alternative or in addition, such parameters can be transmitted to a remote system, for example a remote computer or remote server or a cloud system, by the data communication module, for example the hereinbefore described GSM module.

A possible operative mode of the system 1 according to the invention will be now described.

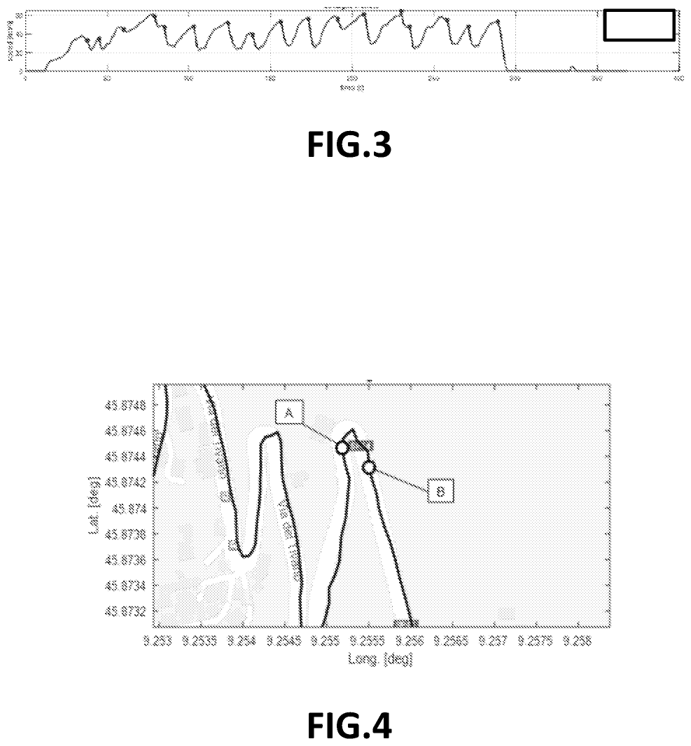

FIG. 2 shows, on a map, the route followed by a cyclist during when a bicycle training. The plot of the route is obtained by detecting the (latitude and longitude) coordinates obtained by the GPS module. Each successive coordinate can be stored as a function of the time. FIG. 3 illustrates the time trend of the bicycle speed. Knowing the time coordinates makes possible to associate the speed to the GPS coordinate. For sake of simplicity, the entire route is assumed as a downhill. On the contrary, the downhill condition can be distinguished from the uphill condition by signals supplied by the inertial measuring unit. The dots of the time-speed diagram of FIG. 2 show the end of each braking action. The control unit 5 can determine the occurrence of a braking action when it receives, at the input, the signal supplied by the beforehand cited braking sensor, if provided.

If the braking sensor is not provided, it is possible to determine the occurrence of a braking action by the signal representative of the angular speed ω₁ of the first wheel. For example, the diagram of FIG. 3 shows speed abrupt reductions which starts and ends with the braking actions. Analytically, the braking actions can be determined for example by analyzing the angular acceleration (obtainable by time deriving the angular speed ω₁ of the first wheel) of the first wheel. If a braking action is performed, the angular acceleration of the first wheel will be subjected to a sudden decrease.

For each (downhill) braking action, the system 1 is capable to supply parameters representative of the cyclist performances. With reference to FIG. 4, for example, it shows a portion of the route illustrated in FIG. 2. Particularly, a specific curve is drawn by bold lines. Such operation of selecting a specific curve can be performed by the cyclist when he/she wants to analyze his/her performances.

For example, the system can supply the following parameters associated to the curve delimited by points A and B:
braking start and end points;
speed at the braking action start;
braking time;
braking distance;
speed at the braking action end;
speed at the cyclist lean start;
speed at the curve end;
lean angle in the curve;
average travelling speed in the curve;
average lean angle in the curve;
travelling time in the curve.

By analyzing such data, the cyclist can understand how he/she can improve his/her performances, for example, by trying to delay the braking point or advance the end braking point.

According to a possible embodiment variant, it is observed that the system can be also used for improving the horizontal cyclist performances. To this purpose, the control unit 5 is advantageously further configured to:
determine, from signals representative of the bicycle kinematic parameters, a horizontal condition;
if the horizontal condition is determined, determine one or more parameters representative of the cyclist horizontal performances;
provide said one or more parameters representative of the horizontal performances to the cyclist.

The parameters representative of the cyclist horizontal performances can be substantially the same parameters provided by the system indicative of the downhill performances. Such parameters representative of the cyclist horizontal performances can be further provided to the cyclist according to the same modes by which the parameters representative of the downhill performances are provided (in other words in real time or “a posteriori”, according to what was hereinbefore described).

Conventionally, the horizontal condition can be established save for a certain tolerance. For example, a slight (uphill or also downhill) slope condition, in other words a slope almost equal to (but different from) 0%, can be considered a horizontal condition. The horizontal condition can be determined by the same modes by which the downhill condition is determined, for examples by signals supplied by the inertial measuring unit or by the slope sensor.

In the present description and in the attached claims, it is observed that the system 1 and also the elements indicated as “module” can be implemented by hardware devices (control central units, for example), by software or by a combination thereof.

A person skilled in the art in order to meet specific contingent needs, could add many additions, modifications, or substitutions of elements with others operatively equivalent to the described embodiments of the system for improving the performances of a cyclist on a bicycle, without falling out of the scope of the attached claims.

1. System for improving the performances of a cyclist on a bicycle, comprising:
one or more sensors adapted to sense kinematic parameters of the bicycle and to provide signals representative of the same;
a control unit configured to:
receive, at the input, the signals from said one or more sensors adapted to sense bicycle kinematic parameters;
determine, from the signals representative of the bicycle kinematic parameters:
the presence or absence of a bicycle downhill condition;
if the downhill condition presence is determined, the presence or absence of a braking action;
one or more parameters representative of the cyclist downhill performances;
make available to the cyclist said one or more parameters representative of the cyclist downhill performances.

2. System according to claim 1, wherein said one or more sensors adapted to sense bicycle kinematic parameters comprise a first sensor for measuring the angular speed (ω₁) of a first wheel of the bicycle, adapted to output a signal representative of the angular speed of the first wheel.

3. System according to claim 2, wherein said control unit is configured to determine the presence of a braking action based on said signal representative of the first wheel angular speed (ω₁).

4. System according to claim 1, wherein said one or more sensors adapted to sense bicycle kinematic parameters comprise a sensor for sensing the braking action by the cyclist on a brake lever of the bicycle, adapted to provide a signal representative of the same, wherein said control unit is configured to determine the presence of a braking action based on said signal representative of the braking action by the cyclist.

5. System according to claim 1, wherein said one or more sensors adapted to sense bicycle kinematic parameters comprise an inertial measuring unit adapted to measure the longitudinal (aₓ) and/or lateral (a_{y}) and/or vertical accelerations (a_{z}), and/or the roll (ωₓ) and/or pitch (ω_{y}) and/or yaw angular speeds (ω_{z}) of the bicycle, and to output signals representative of the same.

6. System according to claim 5, wherein said control unit is configured to determine the presence of a downhill or horizontal condition based on said signals from the inertial measuring unit.

7. System according to claim 1, wherein said one or more sensors adapted to sense bicycle kinematic parameters comprise a slope sensor adapted to supply a signal representative of the same, wherein said control unit is configured to determine the presence of a downhill or horizontal condition based on the signal from said slope sensor.

8. System according to claim 1, wherein the control unit is further configured to:
determine, from the signals representative of the bicycle kinematic parameters, a horizontal condition;
if a horizontal condition is determined, determine one or more parameters representative of the cyclist horizontal performances;
make available to the cyclist said one or more parameters representative of the cyclist horizontal performances.

9. System according to claim 1, further comprising a GPS module adapted to geolocating the bicycle, wherein said control unit is configured to receive at the input a geolocation signal from the GPS module and to provide said one or more parameters representative of the downhill and/or horizontal performances of the cyclist correlated to the geolocation determined by the GPS module.

10. System according to claim 1, wherein said control unit further comprises a counter for counting the time and is further configured to provide said one or more parameters representative of the downhill and/or horizontal performances of the cyclist, correlated to the time.

11. System (1) according to claim 1, further comprising an user interface device connected to the control unit, wherein said control unit is configured to transmit said one or more parameters representative of the downhill and/or horizontal performances of the cyclist, to the user interface device, and to make them available to the cyclist by means of it.

12. System according to claim 1, wherein said control unit comprises a wireless transmission module for communicating with an external mobile device.

13. System according to claim 12, wherein said control unit is configured to make available to the cyclist said parameters representative of the downhill and/or horizontal performances of the cyclist in real time by the external mobile device.

14. System according to claim 8, wherein said control unit is configured to transmit said parameters representative of the downhill and/or horizontal performances of the cyclist, to a remote device, for afterwards making them available to a cyclist by means of it.

15. System according to claim 8, wherein said one or more parameters representative of the downhill and/or horizontal performances of the cyclist comprise at least one of: the absolute position of the bicycle along a path when the braking action starts; the speed of the bicycle when the braking action starts; the absolute position of the bicycle at the end of the braking action; the speed of the bicycle at the end of the braking action; the braking distance; the braking time; the time required to go along a turn; the bicycle lean angle during the turn; the bicycle position at the end of the turn; the bicycle speed at the end of the turn; the average values of one or more of the parameters representative of the downhill and/or horizontal performances of the cyclist, sensed between a starting point and an end point of the path.

16. Bicycle comprising the system according to claim 1.
